(19) United States
(12) Patent Application Publication
(10) Pub. No.: US 2026/0132668 A1
(43) Pub. Date: May 14, 2026

(54) VEHICLE AND DOOR CONTROL METHOD THEREOF

(71) Applicants: Hyundai Motor Company, Seoul (KR); Kia Corporation, Seoul (KR)

(72) Inventor: Keun Sik KIM, Hwaseong-Si (KR)

(21) Appl. No.: 19/326,009

(22) Filed: Sep. 11, 2025

(30) Foreign Application Priority Data
Nov. 13, 2024 (KR) 10-2024-0160672

(51) Int. Cl. E05F 15/76; E05F 15/71; E05F 15/77; E05F 15/79

(52) U.S. Cl. CPC E05F 15/76; E05F 15/71; E05F 15/77; E05F 15/79; E05Y 2900/531

(57) ABSTRACT

Aspects described herein relate to a vehicle and a door control method of the vehicle. The vehicle includes a plurality of door controllers including a memory and a processor; and a plurality of door sensors, wherein a first door controller of the plurality of door controllers controls a first door sensor to detect whether a first user approaches on the basis of a wireless signal received from an authentication unit of the vehicle, and performs processing such that a first door is automatically opened when a first sensing signal is received from the first door sensor sensing approach of the first user; and the first door sensor is one of the plurality of door sensors.

### CROSS-REFERENCE TO RELATED APPLICATION

This application claims priority to and the benefit of Korean Patent Application No. 10-2024-0160672, filed on Nov. 13, 2024, the disclosure of which is incorporated herein by reference in its entirety.

### TECHNICAL FIELD

The present disclosure relates to a vehicle and a door control method thereof. In particular, aspects described herein relate to detecting an approach of a passenger and automatically opening a door of a vehicle based on the type of a wireless signal of an authentication unit (e.g., an authenticator of a device, such as a digital key, a mobile device communicating with a vehicle, etc.).

### BACKGROUND

When a user carries a lot of luggage, opening a vehicle door can be an inconvenient situation. For example, when both hands may be full of luggage, it can be difficult to grab a handle and open a door, and it is possible to open the door only after putting down the luggage. In this process, there may be a risk that the luggage may fall to the ground or get damaged, and especially in rainy or snowy weather, the luggage may get wet or contaminated. Further, when carrying heavy luggage, it can be difficult to apply force needed to open a door, and the door may not properly open and there is also a risk of injury from the hands or body being hit during the process of the door closing.

Further, it may be inconvenient for a driver or passenger to manually open a vehicle door and gets in the vehicle during rainy weather. For example, in a rainy situation, it may be inconvenient to open a vehicle door with a wet handle or to try to open and close a door in the rain (whether or not holding umbrella) while potentially getting clothes or belongings wet. Such inconveniences greatly reduce convenience for vehicle users.

### SUMMARY

Aspects described herein relate to detecting an approach of a passenger and automatically opening a vehicle door. One of the many improvements in this door-opening process is that, when an obstacle is detected in the path of a door's opening, the vehicle can open the door an amount that avoids striking the obstacle with the door.

The technical subjects to implement in the present invention may be not limited to the technical problems described above and other technical subjects that may be not stated herein will be clearly understood by those skilled in the art from the following specifications.

As will be described herein, a vehicle may comprise a plurality of door controllers (which may include a memory and/or a processor) and a plurality of door sensors. A first door controller of the plurality of door controllers may control a first door sensor of the plurality of door sensors to detect whether a first user approaches on a basis of a wireless signal received from an authentication unit of the vehicle. When a first sensing signal is received from the first door sensor sensing approach of the first user, the door controller may cause a first door to which the first door sensor is attached to be opened.

One of the many advantages of the present disclosure is that it may ensure that the door automatically opens based on receiving a signal for a sufficiently long period of time (e.g., corresponding to a person walking up to their vehicle). For example, the wireless signal may comprise an approach determination signal, and the first door controller may automatically open the first door in response to determining, based on the first sensing signal, that the first user has remained in a first door openable area set for the first door for a preset first time.

Aspects described herein may account for different doors and different users. For example, when a first door is a driver's side door and an automatic door opening/closing mode has been set to an ON setting for a second door different from the first door, the second door controller of the plurality of door controllers may automatically open the second door when a second sensing signal is received, via a second door sensor of the plurality of door sensors, in a second door openable area set for the second door. That sensing signal may be a signal generated when the second door sensor attached to the second door detects approach of a second user. In this manner, for example, a passenger might be able to cause opening of their own door. Such a second door might be opened upon detection of a first person as well, such as where a driver is either already in the car or is nearby the first door. As with the first sensor, this opening might be based on a period of time elapsing. For example, the second door may be automatically opened when a second sensing signal is received for a preset second time within preset n seconds (n is a positive number of 1 or more) after the first door is opened.

Another one of the many improvements of the present disclosure is that it may allow for automatic opening of a door even when a user is not within reach of the door. For example, the first door openable area may comprise a radius larger than an opening radius of the first door. In this manner, the door may begin to open while the user walks to the door.

Moreover, aspects described herein may be contingent on weather conditions, such that automatic door opening might be performed in rainy, snowy, and/or otherwise undesirable weather. For example, based on a detection of rain, a first door may be automatically opened to a preset position (e.g., slightly less than a full opening radius, so as to avoid letting excess water in, and/or to a user-defined position) after deterring a first sensing signal in a first door openable area for a preset first time.

Another one of the many improvements of the present disclosure is that it may allow for automatic opening of a door even when obstacles, when an obstacle sensing signal is received from the first door sensor while the first door is being opened, the first door controller may perform processing to stop an opening operation of the first door.

The aspects described herein may apply to a wide variety of doors of vehicle, including rear doors, cargo doors, etc. Moreover, different signals might cause the opening of different doors, such that (for example) a driver might be able to send a signal that ultimately causes opening of a rear door for a passenger. For example, when the wireless signal is a remote door open command signal transmitted from an authentication unit, a third door controller of the plurality of door controllers may automatically open a third door based on determining that a third user has remained in a third door openable area for a preset third time. In such an example, that sensing might be performed by detecting a body of the third user via a third door sensor attached to the third door. In this manner, for example, a parent might send a remote door open command that might ultimately open a rear door for their child when the child gets near the door. The system might allow for a variety of such settings, such as individually setting doors to an ON or OFF automatic opening/closing mode in various conditions (e.g., weather conditions, based on certain signals).

Just as doors might be automatically opened, they might also be automatically closed. For example, a door controller may automatically close a door when a user is not detected (e.g., via a sensor) within a preset time after the third door is opened (whether automatically or manually). In turn, this might allow doors to close (e.g., for security, safety, to preserve air conditioning) if they have been inadvertently left open and/or so as to provide convenience to users (who might otherwise have to manually pull a door closed).

Different wireless signals might cause different types of door opening/closing processes. For example, degrees of opening of a plurality of doors may be different based on a type of the wireless signal. For instance, one user might prefer a wider door opening radius than another in different conditions (e.g., when it is raining, based on the door).

As one example of how aspects described herein might operate, a door control method of a vehicle may include controlling a first door sensor to detect, based on monitoring wireless signals received from an authentication unit of the vehicle, whether a first user approaches a first door controller of a plurality of door controllers. Additionally, the method may comprise, in response to detection of an approach of a user based on such wireless signals, automatically opening the first door using the first door controller. Such an opening might be conditioned on determining that the first user has remained in a first door openable area corresponding to the first door for a preset first time. Similarly, the method may comprise automatically opening, using a second door controller of the plurality of door controllers, a second door based on determining that one or more of (1) the first door is a driver's side door, (2) an automatic door opening/closing mode has been set to ON for the second door, and (3) a second sensing signal has been received in a second door openable area set for the second door from a second door sensor after the first door is opened. As with the first door, the second door might open after determining that a signal has been received for a predetermined period of time (e.g., a certain number of seconds). Moreover, the opening of any door may be additionally and/or alternatively conditioned on determining whether or not adverse weather conditions (e.g., rain) may be present. Also, the method may be performed for an unlimited number of doors of a vehicle: for example, one wireless signal might cause opening of multiple doors based on detection of humans approaching the door, multiple wireless signals might cause opening of different doors based on detection of humans approaching those doors, or the like. Some signals (e.g., for a driver) might cause all doors to open, whereas other signals (e.g., associated with a passenger) might only enable opening of a single door.

The method may also avoid damage to the door, to users, and/or other forms of unintended performance by limiting movement of the door when obstacles may be detected. For example, the method described above may further include stopping an opening operation of the first door when an obstacle sensing signal is received from the first door sensor while the first door is being opened and/or closed.

Aspects described herein may be performed by computing devices, such as a computing device comprising one or more processors and memory storing instructions that cause the performance of one or more steps (e.g., the detection of wireless signals and/or approaching users, causing opening and/or closing of doors). Such computing devices might be part of a variety of the elements described herein, such as part of a door sensor, part of a computing system of a vehicle (e.g., a head unit), or the like. Also, one or more computer-readable media may store instructions that, when executed, cause performance of all or portions of the steps herein.

The features briefly provided above in connection with the present invention may be just examples for describing the present invention and do not limit the scope of the present invention.

### BRIEF DESCRIPTION OF DRAWINGS

The above and other objects, features and advantages of the present invention will become more apparent to those of ordinary skill in the art by describing exemplary embodiments thereof in detail with reference to the accompanying drawings, in which:

FIG. 1 is a view of the exterior of a vehicle;

FIG. 2 is a front view of the vehicle;

FIG. 3 is a schematic view showing the configuration of a vehicle;

FIG. 4 is a block diagram showing a first door controller;

FIG. 5 is an exemplary view showing a movement path of a user;

FIG. 6 is a schematic flowchart showing a door control method of a vehicle according to an aspect of the present disclosure;

FIG. 7 is a flowchart showing the door control method of a vehicle in operation S635 of FIG. 6, i.e., during operation in a first operation mode;

FIG. 8 is a flowchart showing the door control method of a vehicle in operation S640 of FIG. 6, i.e., during operation in a second operation mode;

FIG. 9 is a flowchart showing the door control method of a vehicle in operation S655 of FIG. 6, i.e., during operation in a third operation mode; and

FIG. 10 is a flowchart showing the door control method of a vehicle in operation S660 of FIG. 6, i.e., during operation in a fourth operation mode.

### DETAILED DESCRIPTION

Hereinafter, aspects of the present disclosure will be described in detail with reference to the accompanying drawings so that those skilled in the art to which the present disclosure pertains may easily practice the present disclosure. However, aspects of the present disclosure may be modified in various different forms and is not limited to aspects described herein.

In the present disclosure, when a component is said to be “connected,” “coupled,” or “joined” to another component, this may include not only a direct connection relationship, but also an indirect connection relationship where another component exists therebetween. In addition, when a component “includes” or “has” another component, this means that the component may further include other components, not excluding the inclusion of the other components unless otherwise stated.

In the present disclosure, terms such as “first” and “second” may be used only for the purpose of distinguishing one component from other components, and do not limit the order, importance, or the like of components unless otherwise specified. Accordingly, within the scope of the present disclosure, a first component in an aspect may be referred to as a second component in another aspect, and similarly, a second component in an aspect may be referred to as a first component in other aspects.

In the present disclosure, components distinguished from each other may be intended to clearly explain each feature, and do not mean that the components may be necessarily separated. That is, a plurality of components may be integrated to be formed in a single hardware or software unit, or a single component may be distributed to be formed in a plurality of hardware or software units. Accordingly, even when not described separately, such integrated or distributed aspects may be included in the scope of the present disclosure.

In the present disclosure, components described in various aspects do not necessarily mean essential components, and some of the components may be optional components. Therefore, aspects composed of a subset of components described in an aspect may be also included in the scope of the present disclosure. In addition, aspects including other components in addition to the components described in various aspects may be also included in the scope of the present disclosure.

In the present invention, phrases such as “A or B,” “at least one of A and B,” “at least one of A or B,” “A, B, or C,” “at least one of A, B and C,” and “at least one of A, B, or C” or a combination thereof may include any one of items listed together in the corresponding phrase, or all possible combinations thereof.

Various advantages and features of the present disclosure and methods accomplishing them will become apparent from the following description of aspects with reference to the accompanying drawings. However, the present invention is not limited to exemplary aspects disclosed below but may be implemented in various different forms. These aspects will be provided only in order to make the invention of the present invention complete and allow those skilled in the art to which the present invention pertains to completely recognize the scope of the present invention.

In addition, in this specification, terms such as “module,” “unit,” and “device” may be intended to refer to the functional and structural combination of hardware and software driven by or for driving the hardware. For example, the hardware herein may be a data processing device including a central processing unit (CPU) or another processor. In addition, software driven by hardware may refer to a running process, object, executable file, thread of execution, program, etc.

The term “module” or “unit” used in the specification means a software and/or hardware component, and the “module” or “unit” performs certain operations/functions/roles. However, the “module” or “unit” is not construed as being limited to software or hardware. The “module” or “unit” may be configured to be in an addressable storage medium or to execute one or more processors. Therefore, as an example, the “module” or “unit” may include at least one of components such as software components, object-oriented software components, class components, and task components, processes, functions, attributes, procedures, sub-routines, segments of program codes, drivers, firmware, micro-codes, circuits, data, databases, data structures, tables, arrays, or variables. Functions provided in the components, “modules”, or “units” may be combined into a smaller number of components, “modules”, or “units” or further divided into additional components, “modules”, or “units”.

In the present disclosure, the “module” or “unit” may be realized as a processor and a memory. The “processor” should be widely construed to include a general-purpose processor, a central processing unit (CPU), a microprocessor, a digital signal processor (DSP), a microcontroller, a state machine, or the like. In some environments, the “processor” may refer to an application-specific integrated circuit (ASIC), a programmable logic device (PLD), or a field-programmable gate array (FPGA), and the like. For example, the “processor” may refer to a combination of processing devices such as a combination of a DSP and a microprocessor, a combination of a plurality of microprocessors, a combination of one or more microprocessors combined with a DSP core, or any other such combination. Moreover, the “memory” should be widely construed to include any electronic component capable of storing electronic information. The “memory” may refer to various types of processor-readable medium such as a random access memory (RAM), a read only memory (ROM), a non-volatile random access memory (NVRAM), a programmable read only memory (PROM), an erasable programmable read only memory (EPROM), an electrically erasable programmable read only memory (EEPROM), a flash memory, a magnetic or optical data storage device, and registers. When the processor can read information from a memory and/or record the information in the memory, the memory may be in a state of electronic communication with a processor. Memory integrated into a processor is in a state of electronic communication with the processor.

The one or more features described herein may be provided as a computer program stored in a computer-readable recording medium in order to be executed on a computer. The medium may either continuously store a computer-executable program or temporarily store the program for execution or download. Furthermore, the medium may be a variety of recording or storage means in the form of a single hardware device or multiple combined hardware devices, and is not limited to media directly connected to some computer system but may also be distributed across a network. Examples of such media include magnetic media such as a hard disk, a floppy disk, or a magnetic tape, optical recording media such as a CD-ROM or a DVD, magneto-optical media such as a floptical disk, and a ROM, RAM, or flash memory, among others, configured to store program instructions. Additional examples of such media include media or storage media that are managed by an app store that distributes applications or by various other sites or servers that provide or distribute software.

In a hardware implementation, processing units used for performing the techniques may be implemented within one or more ASICs, DSPs, digital signal processing devices, programmable logic devices, field-programmable gate arrays, processors, controllers, microcontrollers, microprocessors, electronic devices, or computers or combinations thereof designed to perform the functions described in the present disclosure.

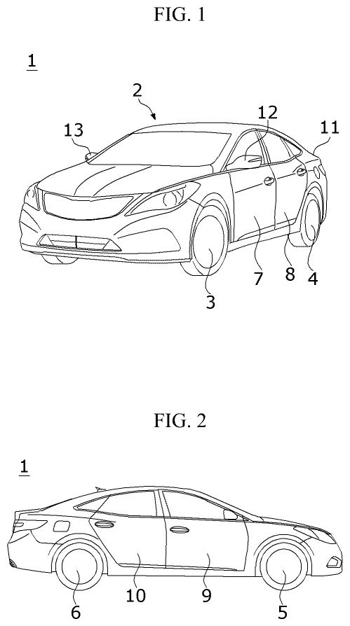

FIG. 1 is a view of the exterior of a vehicle 1, and FIG. 2 is a front view of the vehicle 1.

Referring to FIGS. 1 and 2, the vehicle 1 according to an aspect of the present disclosure may include a main body forming the exterior of the vehicle 1, wheels 3, 4, 5, and 6 for moving the vehicle 1, first to fifth doors 7, 8, 9, 10, and 11 for shielding the interior of the vehicle 1 from the outside, and side mirrors 12 and 13 providing a driver with a view of the rear of the vehicle 1.

In some cases, the first to fourth doors 7 to 10 may be rotatably provided on the left side and the right side of the main body 2 so that a driver can get in the vehicle 1 when the first to fourth doors may be opened, and may shield the interior of the vehicle 1 from the outside when the first to fourth doors may be closed. For purposes of discussion, that the first door 7 may be referred to as the driver's side door, the second door 8 may be referred to as the passenger's side door, the third door 9 may be referred to as the rear left door, the fourth door 10 may be referred to as the rear right door, and the fifth door 11 may be referred to as the trunk door provided at the rear of the main body 2. The vehicle 1 may include other configurations that may be not described, without departing from the scope of the disclosure.

When the vehicle 1 is driven by electric energy, it may be composed of a battery that is charged by a charging station 2 or it may be composed of a combination of a battery and a fuel cell that charges the battery. Further, the vehicle 1 may include an engine that generates rotational force by burning fossil fuels. Further, when the vehicle 1 is a hybrid type, the vehicle 1 may be configured with a combination of an internal combustion engine and an electric battery.

Further, the vehicle 1 may have at least one vehicle controller (e.g., a computing device, such as might have one or more processors and/or memory). The at least one vehicle controller may be provided in the vehicle 1 in the form of an embedded system, and when a plurality of vehicle controllers may be provided, they may be implemented as independent devices for the functions of the vehicle controllers or they may be connected so that they can communicate with each other. Further, the at least one vehicle controller may be implemented integrally with control units in the vehicle or may be implemented as independent separate chips. For example, the at least one controller may be implemented in various types such as an electronic control unit (ECU), a micro controller unit (MCU), a CPU, and a microprocessor.

The functions that the at least one vehicle controller can control may include various vehicle control functions including transmission control, electronic stability control, airbag control tire pressure monitoring, motor control, seat control, door opening/closing control, etc.

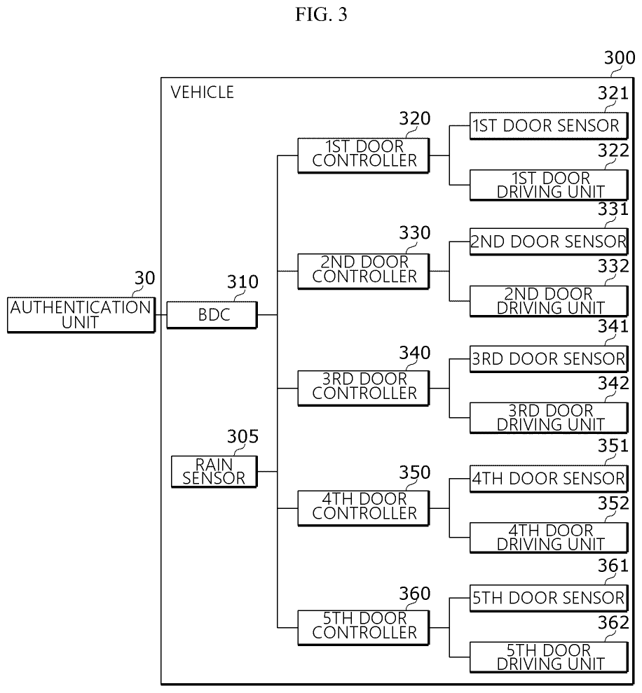

FIG. 3 is a schematic view showing the configuration of the vehicle 1 according to an aspect of the present disclosure.

As shown in FIG. 3, in an aspect of the present disclosure, the vehicle 1 may further include a rain sensor 305, a body domain controller (BDC) 310, first to fifth door controllers 320, 330, 340, 350, and 360, first to fifth door sensors 321, 331, 341, 351, and 361, and first to fifth door driving units 322, 332, 342, 352, and 362. The BDC 310 and the first to fifth door controllers 320, 330, 340, 350, and 360 may be vehicle controllers.

Authentication unit 30 (e.g., an authenticator), which may be a device remotely controlling the vehicle, can command functions such as locking and unlocking the vehicle, remote starting, opening the trunk, etc. The authentication unit 30 may be a device capable of user authentication through wired or wireless communication, and examples include a smart key, a digital key, a wearable key, and the like. The authentication unit 30 may communicate with the BDC 310 of the vehicle 1 through wireless signals so that a user can remotely control various functions of the vehicle 1. The authentication unit 30 may communicate with a wireless transceiver of the vehicle via one or more wireless communication protocols, for example, a radio frequency (RF) signal (e.g., 315 MHz, 433 MHz, etc.), a low frequency (LF) signal for vehicle user proximity detection (e.g., 125 kHz), an ultra-wideband (UWB) signal for vehicle user proximity detection (e.g., 3.1-10.6 GHz), a Bluetooth Low Energy (BLE) for wireless communication pairing with the vehicle, etc. The vehicle may detect a vehicle user based on one or more wireless signals received from the authentication unit 30. Based on detecting the vehicle user, the vehicle may capture an image of the vehicle user. The vehicle may track the movement of the vehicle user and may detect whether the vehicle user is carrying one or more pieces of items (e.g., an umbrella, grocery bags, etc.). The automatic door opening process described herein may be performed and/or adjusted by the vehicle based on at least one of a weather condition or a status of the vehicle user (e.g., the vehicle user is carrying one or more pieces of items).

The rain sensor 305 may switch to a wake-up mode by a wake-up signal, detect whether it is raining, and/or transmit the rain sensing result to the first to fifth door controllers 320, 330, 340, 350, and 360. When a wiper operation mode of the vehicle has been set to an automatic mode, the rain sensor 305 may cause the wipers to operate automatically when rain is detected.

For example, the BDC 310 may be an ECU that integrally manages and controls a plurality of electronic devices in the vehicle 1. For example, the BDC 310 can manage, control, or directly perform functions related to user convenience, such as door locking and unlocking control, lighting control, electric device control, security and alarm system control, power system management, fault diagnosis and warning, trunk automatic opening/closing, and remote starting control.

As an example, in the case of door locking and unlocking control, the BDC 310 may detect a wireless signal sent from the authentication unit 30 and performs functions such as locking and unlocking the vehicle doors and opening the trunk. The BDC 310 may communicate with the authentication unit 30 through one or more low-power radio frequency identification (RFID) antennas, one or more low frequency (LF) antennas, or one or more Radio Frequency antennas. The one or more LF antennas or one or more RF antennas may be provided inside or outside the main body 2.

The authentication unit 30 and the BDC 310 can operate through remote keyless entry (RKE) and the wireless signal sent from the authentication unit 30 may include at least one of a low-power RFID signal, an LF signal, and an RF signal.

For example, the authentication unit 30 can notify the BDC 310 that the authentication unit 30 is approaching by transmitting a low-power RFID signal or an LF signal. Hereafter, the signal that notifies that the authentication unit 30 is approaching, that is, the signal for determining approach of the authentication unit 30, is referred to as an “approach determination signal.” Further, the authentication unit 30 can send a remote command signal to the BDC 310 by transmitting an RF signal. Hereafter, the signal that commands remote door opening by the authentication unit 30 is referred to as a “remote door open command signal.”

For example, when the vehicle 1 is turned off, the BDC 310 may switch to a sleep mode. The BDC 310 keeps the low-power reception module active even in the sleep mode so that it can receive wireless signals from the authentication unit 30. The type of wireless signals may be one of a low-power RFID signal, an LF signal, or an RF signal, as described above.

Accordingly, in the sleep mode, upon receiving a wireless signal from the authentication unit 30, the BDC 310 can switch to a wake-up mode, transmit the received wireless signal and a wake-up signal to the first to fifth door controllers 320, 330, 340, 350, and 360, and transmit a wake-up signal to the rain sensor 305. The BDC 310, the rain sensor 305, and the first to fifth door controllers 320, 330, 340, 350, and 360 can use CAN communication or LIN communication.

The first to fifth door controllers 320, 330, 340, 350, and 360 can switch to a wake-up mode from the sleep mode in accordance with the received wake-up signal and can also control the first to fifth door sensors 321, 331, 341, 351, and 361 and the first to fifth door driving units 322, 332, 342, 352, and 362 to wake up.

The first door controller 320 can control the first door driving unit 322 to automatically open/close the first door 7 on the basis of a signal detected by the first door sensor 321.

The second door controller 330 can control the second door driving unit 332 to open/close the second door 8 on the basis of a signal detected by the second door sensor 331.

The third door controller 340 can control the third door driving unit 342 to open/close the third door 9 on the basis of a signal detected by the third door sensor 341.

The fourth door controller 350 can control the fourth door driving unit 352 to open/close the fourth door 10 on the basis of a signal detected by the fourth door sensor 351.

The fifth door controller 360 can control the fifth door driving unit 362 to open/close the fifth door 11 on the basis of a signal detected by the fifth door sensor 361. The first to fifth door sensors 321, 331, 341, 351, and 361 may detect an obstacle when doors may be opened and closed so that the doors can be opened and closed without damage.

The first to fifth door sensors 321, 331, 341, 351, and 361 may be exemplified by a door collision avoidance sensor (DCAS). The first to fifth door sensors 321, 331, 341, 351, and 361 can detect an obstacle or a user in a door openable area set in a horizontal 180-degree direction and a vertical 180-degree direction. 180 degrees is an example and is not limited thereto.

The first to fifth door driving units 322, 332, 342, 352, and 362 can open/close the first to fifth doors 7, 8, 9, 10, and 11 to set positions. The set positions may be set to positions where a user can get in the vehicle and can be changed or set to default values by a user.

Because the operations of the first to fifth door controllers 320, 330, 340, 350, and 360, the first to fifth door sensors 321, 331, 341, 351, and 361, and the first to fifth door driving units 322, 332, 342, 352, and 362 may be similar, the first door controller 320, the first door sensor 321, and the first door driving unit 322 will be mainly described below.

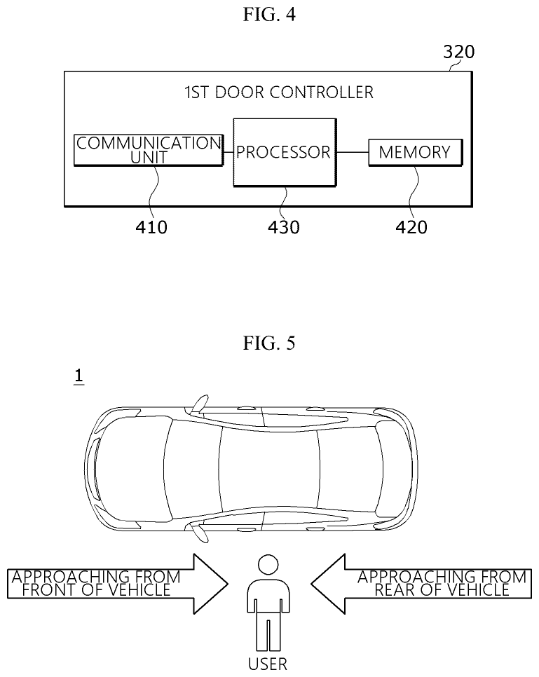

FIG. 4 is a block diagram showing a first door controller 320.

Referring to FIG. 4, the first door controller 320 according to an aspect of the present disclosure may include a communication unit 410, a memory 420, and a processor 430.

The communication unit 410 may include a communication circuit for communication between the components in the vehicle, and for example, may include a circuit for short-range communication and wired/wireless communication. The communication unit 410 can communicate with the BDC 310, the rain sensor 305, the first door sensor 321, and the first door driving unit 322. For example, the communication unit 410 can transmit a rain sensing signal received from the rain sensor 305, and a wireless signal and a wake-up signal received from the BDC 310 to the processor 430.

In some cases, the circuit for short-range communication can support at least one of Bluetooth, infrared communication, RFID communication, wireless local access network (WLAN) communication, NFC communication, and Zigbee communication. The circuit for wired communication can support wireless communication such as controller area network (CAN) communication, local interconnect network (LIN) communication, local area network (LAN) communication, wide area network (WAN) communication, and value added network (VAN) communication, and cable communication such as Universal Serial Bus (USB), High Definition Multimedia Interface (HDMI), Digital Visual Interface (DVI), recommended standard 232 (RS-232 ), power line communication, or plain old telephone service (POTS). The circuit for wireless communication can support at least one of various wireless communication types such as WiFi, wireless broadband, Global System for Mobile Communications (GSM), code division multiple access (CDMA), wideband code division multiple access (WCDMA), Universal Mobile Telecommunications System (UMTS), time division multiple access (TDMA), and Long Term Evolution (LTE).

The memory 420 stores at least one program (for example, an operating system, software, firmware, middleware, or applications, and multiple others), various types of data, and at least one instruction for the operation of the first door controller 320, and can load the program, read out and record the data, and perform an operation corresponding to the instruction in accordance with a request of the processor 430.

The memory may include at least one of storage media such as a random access memory (RAM), a static RAM (SRAM), a read only memory (ROM), a programmable ROM (PROM), erasable PROM (EPROM), an electrically epROM (EEPROM), a hard disk drive (HDD), a solid state disk (SSD), an embedded multimedia card (eMMC), a universal flash storage (UFS), and/or a web storage.

For example, the program stored in the memory 420 may include a door opening/closing program automatically opening/closing the first door 7 of the vehicle 1 on the basis of a wireless signal received from the authentication unit 30.

The processor 430 can control opening/closing of the first door 7 in accordance with input instructions or signals. The instructions or signals can be input to the processor 430 by the memory 420 or the communication unit 410. For example, the processor 430 can control the operation of another component (hardware or software) and perform data processing and computation by executing the program or the instruction stored in the memory 420. Further, the processor 430 can load an instruction or data received from another component to a volatile memory, process an instruction or data stored in the volatile memory, and store the processing result in a nonvolatile memory.

The processor 430, for example, may include at least one of a CPU, a digital signal processor (DSP), an application specific integrated circuit (ASIC), a programmable logic devices (PLD), field programmable gate arrays (FPGAs), microcontrollers, and/or microprocessors.

The processor 430 can switch to the wake-up mode according to a wireless signal or a wake-up signal received from the BDC 310 and can transmit a wake-up command to the first door sensor 321 and the first door driving unit 322. Accordingly, the first door sensor 321 and the first door driving unit 322 can switch to a wake-up state and the first door sensor 321 can detect a user or an obstacle approaching the first door 7.

Further, the processor 430 can operate in one of first to fourth operation modes on the basis of the type of a wireless signal received from the BDC 310 and a rain sensing result received from the rain sensor 305 by executing the door opening/closing program.

The first operation mode is a mode of operating to automatically open/close a door when an access determination signal is received on a clear day, rather than during rain.

The second operation mode is a mode of operating to automatically open/close a door when an access determination signal is received during rain.

The third operation mode is a mode of operating to automatically open/close a door when a remove door open command signal is received on a clear day, rather than during rain.

The fourth operation mode is a mode of operating to automatically open/close a door when a remote door open command signal is received during rain.

Further, the processor 430 can control opening/closing of the first door 7 on the basis of the type of a received wireless signal and a first sensing signal (or a user position signal) received from the first door sensor 321. The first sensing signal is a signal generated when the first door sensor 321 detects a first user in a first door openable area.

For example, the processor 430 can control the first door sensor 321 to detect whether a first user approaches on the basis of a wireless signal received from the authentication unit 30 of the vehicle 1, and can control the first door driving unit 322 to automatically open the first door to which the first door sensor 321 is attached when a first sensing signal is received from the first door sensor 321 sensing approach of the first user. That is, the processor 430 can operate in the first operation mode or the third operation mode.

In this case, the processor 430 can control the first door driving unit 322 such that the first door 7 is opened to a position set in advance by a user through a user setting menu (USM). A user can set an angle to which the first door 7 is automatically opened through a USM in an audio video navigation and telematics (AVNT) device. When there is no position set by a user, the processor 430 can control the first door 7 to be opened to a default position set in the production process operation. The default position is a position where a user can get in without touching the first door 7.

When a received wireless signal is a signal for approach determination of the authentication unit 30 (hereafter referred to as an “approach determination signal”), that is, an LF signal, the processor 430 analyzes a first sensing signal that is received in real time from the first door sensor 321. As the result of the analysis, when the first sensing signal is received from the first door sensor 321 for a first time, the processor 430 can control the first door driving unit 322 such that the first door 7 is automatically opened. That is, based on determining that a first user remains in the first door openable area for a first time after approaching the first door 7, the processor 430 performs processing such that the first door 7 is automatically opened.

In this case, when the first user is positioned between the first door 7 and the second door 8 and in the first door openable area, the processor 430 may start to determine whether the first user remains for the first time. This may be because when the first user is positioned between the first door 7 and the side mirror 12, the first user is determined as an obstacle and it is difficult to open the first door 7. Further, as shown in FIG. 5, when the first user moves from the front to the rear of the vehicle 1 and stops at the rear seat between the first door 7 and the second door 8 and/or when the first user moves from the rear to the front of the vehicle 1 and stops at the rear seat without passing the first door 7, the processor 430 can analyze a first sensing signal received at least for the first time and perform processing such that the first door 7 is automatically opened.

The first door openable area is an area set to detect the first user who is approaching the first door 7 when a wireless signal is received and may be set on the basis of a radius larger than the opening radius of the first door 7. Further, the first door openable area may be set between the first door 7 and the second door 8. Further, the first door openable area may be changed, depending on the detectable distance of the first door sensor 321.

Further, the processor 430 may output a beep sound a set number of times (for example, 5 times) when the first user, for example, remains for 3 seconds after being detected in the first door openable area, and when the first user is detected in the first door openable area even while the beep sound is being output, the processor 430 can also control the first door driving unit 322 to open the first door 7 at that moment. This is for preventing the first door 7 from opening when the first user approaches and then moves away from the first door 7.

When the first door 7 is opened, the processor 430 transmits a first door open signal to the second to fifth door controllers 330 to 360. The first door open signal is a signal indicating that the first door 7 has been automatically opened.

For example, the second door controller 330 receiving the first door open signal may determine whether an automatic door opening/closing mode for the second door 8 has been set to ON. When it has been set to ON, the second door controller 330 can perform processing such that the second door 8 is automatically opened when a second sensing signal is received from the second door sensor 331 at least for a second time within n seconds (n is a positive number of 1 or more) after the first door 7 is opened. For example, n seconds may be 5 seconds and the second time may be 3 seconds, but the present disclosure is not limited thereto.

In this case, the automatic door opening/closing mode is a mode of automatically opening a door when a wireless signal is received from the authentication unit 30 and a user is approaching the door. The second sensing signal is a signal detected in a second door openable area and the second door openable area is an area set to detect a second user who is approaching the second door 8.

Upon receiving the first door open signal, the third to fifth door controllers 34 to 360 also operate in the same way as the second door controller 330 described above, and therefore detailed description will be omitted for the convenience of description.

Further, the processor 430 may control automatic opening/closing of a door in greater consideration of whether it is raining. That is, the processor 430 can further operate in the second operation mode or the fourth operation mode.

For example, when it is determined to be raining from a rain sensing result received from the rain sensor 305, the processor 430 can control the first door driving unit 322 such that the first door 7 is opened to a position set in user options when an RKE wireless signal is received from the authentication unit 30 for a preset first time in the first door openable area and a first sensing signal is received from the first door sensor 321 for the first time. The user options may be USM settings, and a user can further prevent rain from entering the vehicle 1 by setting the opening angle of the first door 7 to be smaller than a default value during rain.

When an obstacle sensing signal is received from the first door sensor 321 while the first door 7 is being opened during rain, the processor 430 may control the first door driving unit 322 to stop the opening operation of the first door 7.

Further, the processor 430 may transmit a first door open signal to the second to fifth door controllers 330 to 360. For example, when the automatic door opening/closing mode has been set to ON for the second door 8, the second door controller 330 receiving the first door open signal can perform processing such that the second door 8 is automatically opened when a second sensing signal is received from the second door sensor 331 for the second time within n seconds after the first door 7 is opened.

If/when a wireless signal received from the authentication unit 30 is a remote door open command signal, that is, an RF signal, the second to fifth door controllers 330 to 360 may analyze second to fifth sensing signals received in real time from the second to fifth door sensors 331, 341, 351, and 361. This is for preventing accidents that may occur due to automatic opening of the first door 7 that is the driver's side door when the remote door open command signal is received.

For example, based on determining that a third user remains in a third door openable area for a preset third time after approaching the third door 9 as the result of analyzing a third sensing signal, the third door controller 340 can control the third door driving unit 342 such that the third door 9 is automatically opened. The third sensing signal is a signal generated when the third door sensor 341 detects the third user in the third door openable area.

Further, when a third sensing signal is further received within a set m seconds (for example, 10 seconds) after the third door 9 is opened, the third door controller 340 can control the third door driving unit 342 to keep the third door 9 open.

Further, when a third sensing signal is not further received within the set m seconds after the third door 9 is opened, the third door controller 340 can control the third door driving unit 342 to automatically close the third door 9.

An aspect of the present invention prevents automatic opening of the first door 7 that is the driver's side door when a remote door open command signal is received, but this may be changed by USM settings by a user. That is, when a remote door open command signal is received, the first door controller 320 can also control automatic opening/closing of the first door 7.

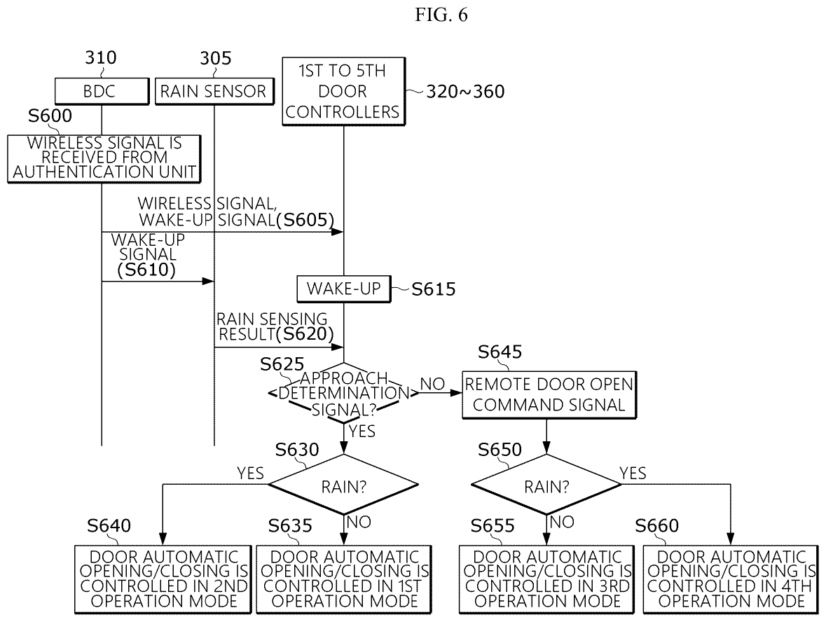

Hereafter, a door control method of a vehicle according to an aspect of the present disclosure is described with reference to FIGS. 6 to 10.

FIG. 6 is a schematic flowchart showing a door control method of a vehicle 1 according to an aspect of the present disclosure.

Referring to FIG. 6, when a wireless signal is received from the authentication unit 30 (S600), the BDC 310 can transmit a wireless signal and a wake-up signal to the first to fifth door controllers 320, 330, 340, 350, and 360 (S605) and can transmit a wake-up signal to the rain sensor 305.

The first to fifth door controllers 320, 330, 340, 350, and 360 switch to the wake-up mode in accordance with a wireless signal and a wake-up signal received in operation S610 (S615).

The rain sensor 305 can detect whether it is raining after switching to the wake-up mode, and can transmit the rain sensing result to the first to fifth door controllers 320, 330, 340, 350, and 360.

When the wireless signal received in operation S610 is a low-power RFID signal or an LF signal, that is, an approach determination signal (S625—Y), the first to fifth door controllers 320, 330, 340, 350, and 360 can determine whether it is raining from the rain sensing result (S630).

Based on determining that it is not raining (S630—N), the first to fifth door controllers 320, 330, 340, 350, and 360 can operate in the first operation mode in which a door is automatically opened/closed when an approach determination signal is received in clear weather (S635).

Further, based on determining that it is raining (S630—Y), the first to fifth door controllers 320, 330, 340, 350, and 360 can operate in the second operation mode in which a door is automatically opened/closed when an approach determination signal is received during rain (S640).

Further, when the wireless signal received in operation S610 is determined as a remote door open command signal, that is, an RF wireless signal (S625—N, S645), the first to fifth door controllers 320, 330, 340, 350, and 360 can determine whether it is raining from the rain sensing results (S650).

Based on determining that it is not raining (S650—N), the first to fifth door controllers 320, 330, 340, 350, and 360 can operate in the third operation mode in which a door is automatically opened/closed when a remote door open command signal is received in clear weather (S655).

Further, based on determining that it is raining (S650—Y), the first to fifth door controllers 320, 330, 340, 350, and 360 can operate in the fourth operation mode in which a door is automatically opened/closed when a remote door open command signal is received during rain (S660).

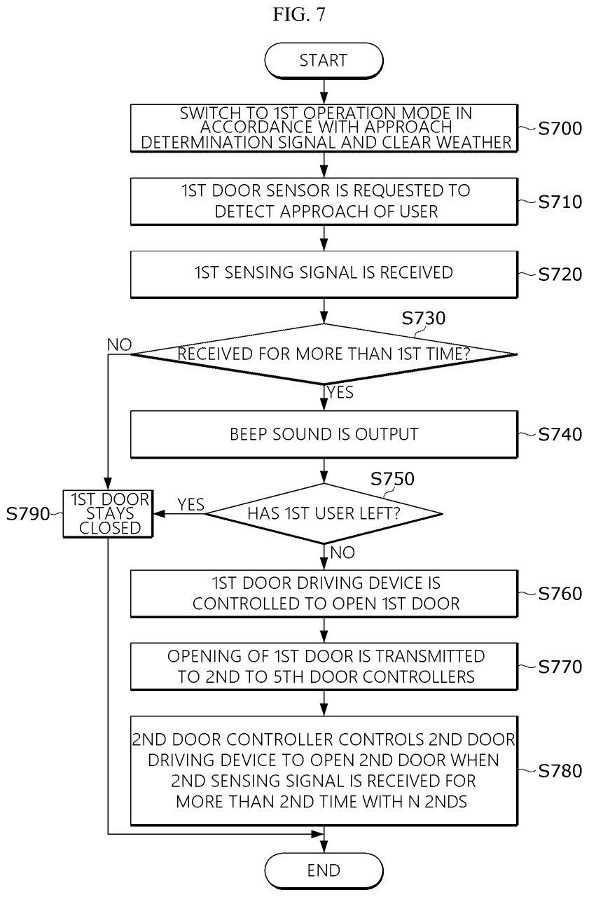

FIG. 7 is a flowchart showing the door control method of a vehicle in operation S635 of FIG. 6, i.e., during operation in a first operation mode.

The method shown in FIG. 7 is described by exemplifying the first door controller 320.

Referring to FIGS. 6 and 7, the first door controller 320 can switch to the first operation mode on the basis of an approach determination signal received in operation S605 and a rain sensing result (clear weather) received in operation S620 (S700) and can control the first door sensor 321 to detect whether a first user is approaching (S710). The first door controller 320 can perform operation S710 when an automatic door opening/closing mode has been set to ON for the first door.

The first door sensor 321 switches to the wake-up mode according to the approach determination signal received from the first door controller 320, and creates a first sensing signal and transmits it to the first door controller 320 when a first user who is approaching the first door 7 is detected in the first door openable area. Accordingly, the first door controller 320 can receive the first sensing signal from the first door sensor 321 (S720). In operation S720, the first sensing signal can be continuously or periodically transmitted to the first door controller 320 until the first user leaves the first door openable area.

When the first sensing signal is received for more than a preset first time (S730—Y), the first door controller 320 determines that the first user remains in the first door openable area and can output a beep sound a set number of times (S740).

Based on determining that the first user has not left the first door openable area while the beep sound is being output the set number of times (S750—N), the first door controller 320 can control the first door driving unit 322 to open the first door 7 (S760). The first door controller 320 can determine operation S730 and operation S760 on the basis of the time for which the first sensing signal is continuously received from the first door sensor 321.

When the first door 7 is the driver's side door, the first door controller 320 informs the second to fifth door controllers 330 to 360 that the first door 7 is open (S770).

Thereafter, when a second sensing signal is received from the second door sensor 331 for more than a second time within n seconds after the first door 7 is opened, the second door controller 330 can control the second door driving unit 332 to open the second door 8 (S780). In operation S780, when an automatic door opening/closing mode (USM settings) has been set to ON for the second door, the second door controller 330 can control the second door driving unit 332 to open the second door 8.

On the other hand, based on determining that the first user has remained in the first door openable area for less than the first time and then left (S730—N) in operation S740 or the first user left the first door openable area while the beep sound was being output (S750—Y) in operation S750, the first door controller 320 can perform processing such that the closed state of the first door 7 is maintained. Accordingly, the first user can manually open the first door 7.

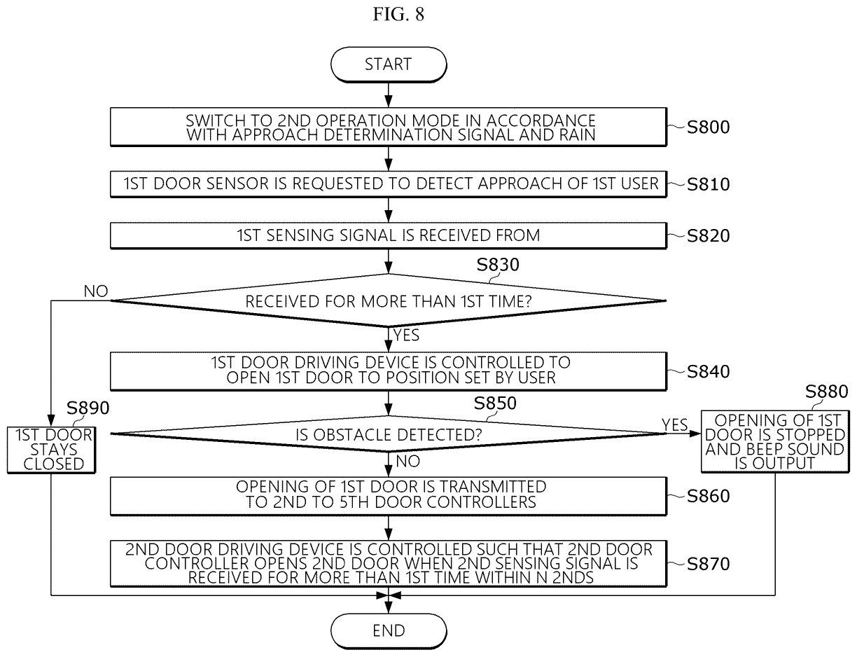

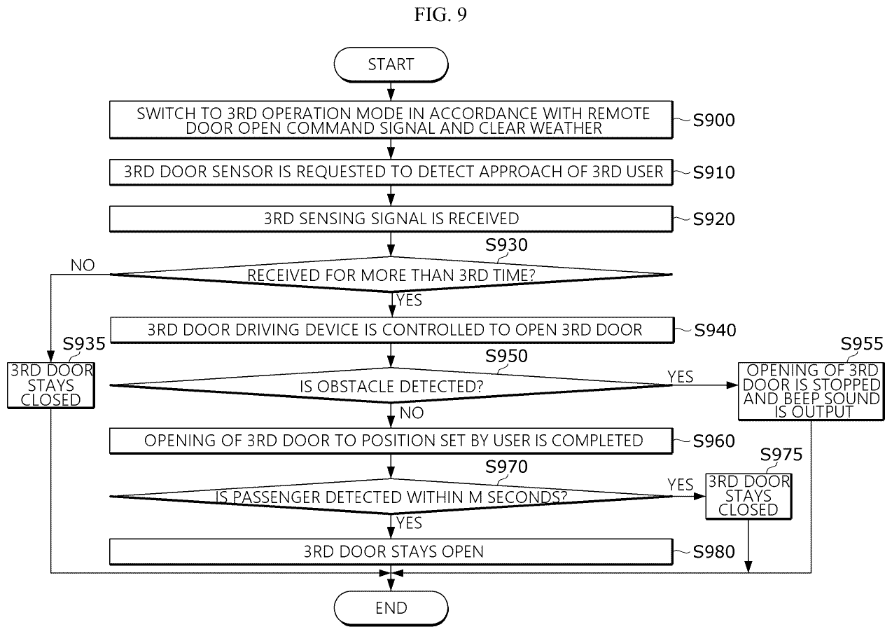

FIG. 8 is a flowchart showing the door control method of a vehicle in operation S640 of FIG. 6, i.e., during operation in a second operation mode.

The method shown in FIG. 8 is described by exemplifying the first door controller 320.

Referring to FIGS. 6 and 8, the first door controller 320 can switch to the second operation mode on the basis of an approach determination signal received from operation S605 and a rain sensing result (during rain) received from operation S620 (S800) and can control the first door sensor 321 to detect whether a first user is approaching (S810).

When a first sensing signal starts to be received from the first door sensor 321 (S820), the first door controller 320 can control the first door driving unit 322 to open the first door 7 to a position set by a user through a USM menu when an approach determination signal from the authentication unit 30 and the first sensing signal may be received for more than a preset first time (S830—Y) (S840).

When an obstacle is not detected by the first door sensor 321 while the first door 7 is being opened (S850—N), the first door controller 320 can wait until the first door 7 is opened to the set position and can inform the second to fifth door controllers 330 to 360 that the first door 7 has been opened (S860).

When a second sensing signal is received from the second door sensor 331 for more than the first time within n seconds after the first door 7 is opened, the second door controller 330 can control the second door driving unit 332 to open the second door 8 (S870).

On the other hand, when an obstacle is detected by the first door sensor 321 while the first door 7 is being opened in operation S850 (S850—Y), the first door controller 320 controls the first door driving unit 322 to stop opening of the first door 7 and outputs a beep sound (S880).

Further, when the first user has remained in the first door openable area for less than the first time and then left or the approach determination signal is received for less than the first time (S830—N) in operation S830, the first door controller 320 can perform processing such that the closed state of the first door 7 is maintained (S890). Accordingly, the first user can manually open the first door 7.

FIG. 9 is a flowchart showing the door control method of a vehicle in operation S655 of FIG. 6, i.e., during operation in a third operation mode.

The method shown in FIG. 9 is described by exemplifying the third door controller 340.

Referring to FIGS. 6 and 9, the third door controller 340 can switch to the third operation mode on the basis of a remote door open command signal received from operation S605 and a rain sensing result (clear weather) received from operation S620 (S900) and can control the third door sensor 341 to detect whether a third user is approaching (S910). The third door controller 340 can perform operation S910 when an automatic door opening/closing mode has been set to ON for the third door.

The third door controller 340 can receive the third sensing signal from the third door sensor 341 (S920). In operation S920, the third sensing signal can be continuously or periodically transmitted to the third door controller 340 until the third user leaves the third door openable area.

When the third sensing signal is received for more than a preset third time (S930—Y), the third door controller 340 determines that the third user remains in the third door openable area and can control the third door driving unit 342 to open the third door 9 (S940).

When an obstacle is not detected by the third door sensor 341 (S950—N) while the third door 9 is being opened, and when the third door 9 is opened to a position set by a user (S960), the third door controller 340 determines whether the third user is detected within m seconds after the third door 9 is opened (S970). Operation S970 can be determined on the basis of whether the third signal is continuously received by the third door sensor 341.

When a passenger is detected within m seconds (S970—Y), that is, when the third sensing signal is further received, the third door controller 340 controls the third door driving unit 342 to keep the third door 9 open (S980).

On the other hand, based on determining that the third user has remained in the third door openable area for less than a third time and then left in operation S930 (S930—N), the third door controller 340 performs processing such that the closed state of the third door 9 is maintained (S935).

Further, when an obstacle is detected in operation S950 (S950—Y), the third door controller 340 can stop opening of the third door 9 and output a beep sound (S955).

Further, when a passenger is not further detected within m seconds in operation S970 (S970—N), the third door controller 340 can control the third door driving unit 342 such that the third door is automatically closed (S975).

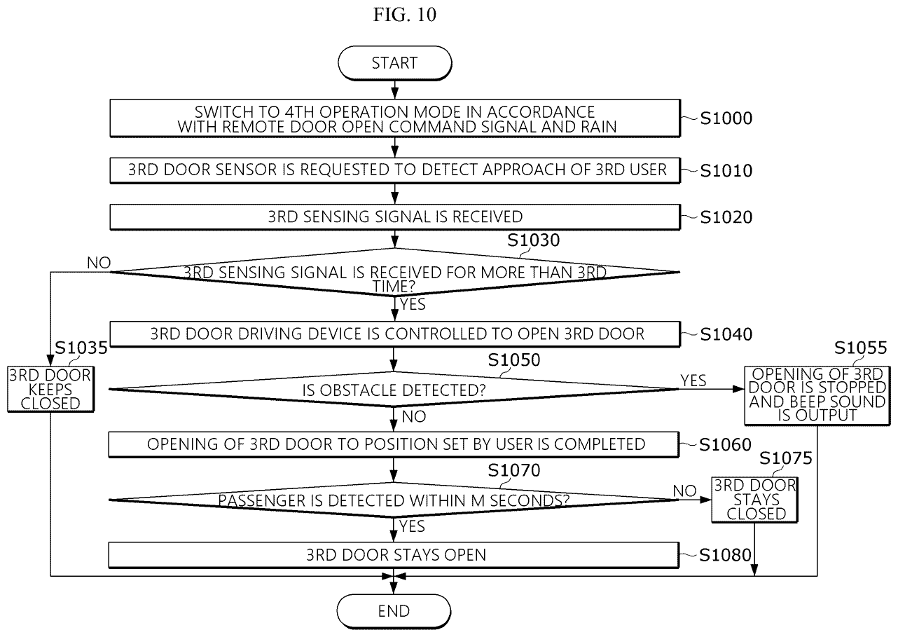

FIG. 10 is a flowchart showing the door control method of a vehicle in operation S660 of FIG. 6, i.e., during operation in a fourth operation mode.

The method shown in FIG. 10 is described by exemplifying the third door controller 340.

Referring to FIGS. 6 and 10, the third door controller 340 can switch to the fourth operation mode on the basis of a remote door open command signal received from operation S605 and a rain sensing result (during rain) received from operation S620 (S1000) and can control the third door sensor 341 to detect whether a third user is approaching (S1010).

When a third sensing signal starts to be received from the third door sensor 341 (S1020), the third door controller 340 can control the third door driving unit 342 to open the third door 9 to a position set by a user through a USM menu when the third sensing signal is received for more than a preset third time (S1030—Y) (S1040).

When an obstacle is not detected by the third door sensor 341 (S1050—N) while the third door 9 is being opened, and when the third door 9 is opened to a position set by a user (S1060), the third door controller 340 determines whether a passenger is detected within m seconds after the third door 9 is opened (S1070).

When a passenger is detected within m seconds (S1070—Y), the third door controller 340 controls the third door driving unit 342 to keep the third door 9 open (S1080).

On the other hand, based on determining that the third user has remained in the third door openable area for less than the third time and then left in operation S1030 (S1030—N), the third door controller 340 performs processing such that the closed state of the third door 9 is maintained (S1035).

Further, when an obstacle is detected in operation S1050 (S1050—Y), the third door controller 340 stops opening of the third door 9 and outputs a beep sound (S1055).

Further, when a passenger is not further detected within m seconds in operation S1070 (S1070—N), the third door controller 340 can control the third door driving unit 342 such that the third door is automatically closed (S1075).

According to the present disclosure, it is possible to sense approach of a passenger and automatically open the doors of a vehicle, and it is possible to increase convenience for a driver and passengers and enhance the sense of luxury of a vehicle by controlling a door to be opened before it reaches an obstacle when an obstacle is sensed in the opening path of the door.

The effects of the present disclosure may be not limited to the effects described above and other effects can be clearly understood by those skilled in the art from the following description.

Various aspects of the present disclosure may be intended to explain representative aspects of the present invention, rather than listing all possible combinations, and matters described in various aspects may be applied independently or in a combination of two or more.

In addition, various aspects of the present disclosure may be implemented by hardware, firmware, software, a combination thereof, or the like. For implementation by hardware, various aspects of the present disclosure may be implemented by one or more ASICs, DSPs, digital signal processing devices (DSPDs), PLDs, FPGAs, processors, controllers, microcontrollers, microprocessors, and the like.

The scope of the present disclosure may include software or machine-executable instructions (e.g., operating systems, applications, firmware, programs, etc.) that cause operations according to the methods of various aspects to be executed on a device or computer, and a non-transitory computer-readable medium in which such software, instructions, etc., may be stored and executable on a device or computer.

As will be described herein, a vehicle may comprise a plurality of door controllers (which may include a memory and/or a processor) and a plurality of door sensors. A first door controller of the plurality of door controllers may control a first door sensor of the plurality of door sensors to detect whether a first user approaches on a basis of a wireless signal received from an authentication unit of the vehicle. When a first sensing signal is received from the first door sensor sensing approach of the first user, the door controller may cause a first door to which the first door sensor is attached to be opened.

One of the many advantages of the present disclosure is that it may ensure that the door automatically opens based on receiving a signal for a sufficiently long period of time (e.g., corresponding to a person walking up to their vehicle). For example, the wireless signal may comprise an approach determination signal, and the first door controller may automatically open the first door in response to determining, based on the first sensing signal, that the first user has remained in a first door openable area set for the first door for a preset first time.

Aspects described herein may account for different doors and different users. For example, when a first door is a driver's side door and an automatic door opening/closing mode has been set to an ON setting for a second door different from the first door, the second door controller of the plurality of door controllers may automatically open the second door when a second sensing signal is received, via a second door sensor of the plurality of door sensors, in a second door openable area set for the second door. That sensing signal may be a signal generated when the second door sensor attached to the second door detects approach of a second user. In this manner, for example, a passenger might be able to cause opening of their own door. Such a second door might be opened upon detection of a first person as well, such as where a driver is either already in the car or is nearby the first door. As with the first sensor, this opening might be based on a period of time elapsing. For example, the second door may be automatically opened when a second sensing signal is received for a preset second time within preset n seconds (n is a positive number of 1 or more) after the first door is opened.

Another one of the many improvements of the present disclosure is that it may allow for automatic opening of a door even when a user is not within reach of the door. For example, the first door openable area may comprise a radius larger than an opening radius of the first door. In this manner, the door may begin to open while the user walks to the door.

Moreover, aspects described herein may be contingent on weather conditions, such that automatic door opening might be performed in rainy, snowy, and/or otherwise undesirable weather. For example, based on a detection of rain, a first door may be automatically opened to a preset position (e.g., slightly less than a full opening radius, so as to avoid letting excess water in, and/or to a user-defined position) after deterring a first sensing signal in a first door openable area for a preset first time.

Another one of the many improvements of the present disclosure is that it may allow for automatic opening of a door even when obstacles, when an obstacle sensing signal is received from the first door sensor while the first door is being opened, the first door controller may perform processing to stop an opening operation of the first door.

The aspects described herein may apply to a wide variety of doors of vehicle, including rear doors, cargo doors, etc. Moreover, different signals might cause the opening of different doors, such that (for example) a driver might be able to send a signal that ultimately causes opening of a rear door for a passenger. For example, when the wireless signal is a remote door open command signal transmitted from an authentication unit, a third door controller of the plurality of door controllers may automatically open a third door based on determining that a third user has remained in a third door openable area for a preset third time. In such an example, that sensing might be performed by detecting a body of the third user via a third door sensor attached to the third door. In this manner, for example, a parent might send a remote door open command that might ultimately open a rear door for their child when the child gets near the door. The system might allow for a variety of such settings, such as individually setting doors to an ON or OFF automatic opening/closing mode in various conditions (e.g., weather conditions, based on certain signals).

Just as doors might be automatically opened, they might also be automatically closed. For example, a door controller may automatically close a door when a user is not detected (e.g., via a sensor) within a preset time after the third door is opened (whether automatically or manually). In turn, this might allow doors to close (e.g., for security, safety, to preserve air conditioning) if they have been inadvertently left open and/or so as to provide convenience to users (who might otherwise have to manually pull a door closed).

Different wireless signals might cause different types of door opening/closing processes. For example, degrees of opening of a plurality of doors may be different based on a type of the wireless signal. For instance, one user might prefer a wider door opening radius than another in different conditions (e.g., when it is raining, based on the door).

As one example of how aspects described herein might operate, a door control method of a vehicle may include controlling a first door sensor to detect, based on monitoring wireless signals received from an authentication unit of the vehicle, whether a first user approaches a first door controller of a plurality of door controllers. Additionally, the method may comprise, in response to detection of an approach of a user based on such wireless signals, automatically opening the first door using the first door controller. Such an opening might be conditioned on determining that the first user has remained in a first door openable area corresponding to the first door for a preset first time. Similarly, the method may comprise automatically opening, using a second door controller of the plurality of door controllers, a second door based on determining that one or more of (1) the first door is a driver's side door, (2) an automatic door opening/closing mode has been set to ON for the second door, and (3) a second sensing signal has been received in a second door openable area set for the second door from a second door sensor after the first door is opened. As with the first door, the second door might open after determining that a signal has been received for a predetermined period of time (e.g., a certain number of seconds). Moreover, the opening of any door may be additionally and/or alternatively conditioned on determining whether or not adverse weather conditions (e.g., rain) may be present. Also, the method may be performed for an unlimited number of doors of a vehicle: for example, one wireless signal might cause opening of multiple doors based on detection of humans approaching the door, multiple wireless signals might cause opening of different doors based on detection of humans approaching those doors, or the like. Some signals (e.g., for a driver) might cause all doors to open, whereas other signals (e.g., associated with a passenger) might only enable opening of a single door.

The method may also avoid damage to the door, to users, and/or other forms of unintended performance by limiting movement of the door when obstacles may be detected. For example, the method described above may further include stopping an opening operation of the first door when an obstacle sensing signal is received from the first door sensor while the first door is being opened and/or closed.

Aspects described herein may be performed by computing devices, such as a computing device comprising one or more processors and memory storing instructions that cause the performance of one or more steps (e.g., the detection of wireless signals and/or approaching users, causing opening and/or closing of doors). Such computing devices might be part of a variety of the elements described herein, such as part of a door sensor, part of a computing system of a vehicle (e.g., a head unit), or the like. Also, one or more computer-readable media may store instructions that, when executed, cause performance of all or portions of the steps herein.

What is claimed is:

1. A vehicle comprising:
a plurality of door controllers comprising a memory and a processor; and
a plurality of door sensors comprising a first door sensor,
wherein a first door controller of the plurality of door controllers is configured to:
control the first door sensor of the plurality of door sensors to detect whether a first user approaches based on a wireless signal received from an authenticator associated with the vehicle; and
cause, based on a first sensing signal received from the first door sensor sensing approach of the first user, automatic opening of a first door.

2. The vehicle of claim 1, wherein, based on a determination that the wireless signal is an approach determination signal for determining an approach of the authenticator, the first door controller is configured to cause the automatic opening of the first door by determining based on the first sensing signal, that the first user has remained in a first door openable area set for the first door for a preset first time.

3. The vehicle of claim 2, wherein the first door is a driver's side door, wherein an automatic door opening/closing mode has been set to ON for a second door different from the first door, wherein a second door controller of the plurality of door controllers is configured to automatically open the second door after the first door is opened based on a second sensing signal received in a second door openable area set for the second door from a second door sensor of the plurality of door sensors, and wherein
the second sensing signal is a signal generated when the second door sensor detects approach of a second user.

4. The vehicle of claim 3, wherein the second door controller is configured to automatically open the second door based on a determination that the second sensing signal is received for a preset second time within preset n seconds after the first door is opened, and wherein n is a positive number greater than or equal to one.

5. The vehicle of claim 2, wherein the first door openable area is based on a radius larger than an opening radius of the first door.

6. The vehicle of claim 1, wherein the first door controller is configured to cause the automatic opening of the first door based on determining that it is raining.

7. The vehicle of claim 6, wherein the first door controller is configured to stop the automatic opening of the first door based on an obstacle sensing signal received from the first door sensor while the first door is being opened.

8. The vehicle of claim 1, wherein a third door controller of the plurality of door controllers is configured to cause automatic opening of a third door based on:
the wireless signal, and
a determination, based on third sensing signal detected by a third door sensor, that a third user has remained in a third door openable area for a preset third time.

9. The vehicle of claim 8, wherein the third door is a door other than a driver's side door and is a door for which an automatic door opening/closing mode has been set to ON.

10. The vehicle of claim 8, wherein the third door controller is further configured to automatically close the third door after the third user is not detected within a preset time after the third door is opened.

11. The vehicle of claim 1, wherein a degrees of opening of the first door is different based on at least one of:
a type of the wireless signal, or
a weather condition.

12. A door control method performed by a vehicle, the method comprising:
controlling, via a first door controller of a plurality of door controllers, a first door sensor to detect whether a first user approaches based on a wireless signal received from an authenticator associated with the vehicle; and
causing, based on a first sensing signal received from the first door sensor sensing approach of the first user and via the first door controller, automatic opening of a first door.

13. The door control method of claim 12, wherein the causing the automatic opening of the first door is based on determining, based on the first sensing signal, that the first user has remained in a first door openable area set for the first door for a preset first time.

14. The door control method of claim 13, further comprising:
causing, based on a second sensing signal received from a second door sensor sensing approach of a second user and after the causing the automatic opening of the first door, automatic opening of a second door.

15. The door control method of claim 14, wherein the causing the automatic opening of the second door is based on the second sensing signal being received for a preset second time within preset n seconds after the first door is opened, and wherein n is a positive number greater than or equal to one.

16. The door control method of claim 13, wherein the first door openable area is set based on a radius larger than an opening radius of the first door.

17. The door control method of claim 12, further comprising:
determining whether it is raining, wherein the causing the automatic opening of the first door comprises causing opening of the first door based on a radius corresponding to rain.

18. The door control method of claim 12, further comprising:
based on an obstacle sensing signal received from the first door sensor while the first door is being opened, causing the first door to stop opening.

19. A vehicle comprising:
a wireless transceiver configured to receive at least one wireless signal from an authenticator associated with the vehicle;
a plurality of door controllers;
a plurality of door sensors; and
one or more processors and memory storing instructions that, when executed by the one or more processors, cause the vehicle to:
detect, via a first door sensor of the plurality of door sensors and based on a wireless signal received from the authenticator associated with the vehicle, that a first user approaches a first door of the vehicle; and
based on the detecting that the first user approaches the first door, causing automatic opening of the first door.

20. The vehicle of claim 19, wherein the at least one wireless signal comprises at least one of a Bluetooth Low Energy (BLE) signal or a ultra-wideband (UWB) signal, and wherein a radius of the automatic opening of the first door is based on one or more of:
a setting corresponding to the authenticator, or
weather conditions.
